(19) United States
(12) Patent Application Publication
(10) Pub. No.: US 2016/0334669 A1
(43) Pub. Date: Nov. 17, 2016

(54) POLARIZING PLATE AND LIQUID CRYSTAL DISPLAY PANEL

(71) Applicant: Shenzhen China Star Optoelectronics Technology Co. Ltd., Shenzhen (CN)

(72) Inventors: Ji LI, Shenzhen (CN); Hsiaohsien Chen, Shenzhen (CN)

(21) Appl. No.: 14/779,014

(22) PCT Filed: Aug. 10, 2015
(86) PCT No.: PCT/CN2015/086458

§ 371 Date: Sep. 22, 2015

(30) Foreign Application Priority Data
May 14, 2015 (CN) 201510244249.1

(51) Int. Cl. G02F 1/1335; H05F 3/00

(52) U.S. Cl. CPC G02F 1/133528; G02F 1/133514; H05F 3/00; G02F 2201/50; G02F 2202/28

(57) ABSTRACT

A polarizing plate is disclosed, and has a polarizing layer, supporting layers, a surface protective layer, a peeling protective layer and an adhesive layer. The polarizing layer is configured to emit an incident light after performing a polarizing process. The supporting layers are used to protect the polarizing layer. The surface protective layer is configured to isolate an upper surface of the polarizing layer from the external environment. The peeling protective layer is configured to isolate a lower surface of the polarizing layer from the external environment. The adhesive layer is configured to adhere the polarizing plate to an array substrate or a color filter substrate.

### FIELD OF THE INVENTION

The present invention relates to a field of polarizing plate production, and more particularly to a polarizing plate and a liquid crystal display panel.

### BACKGROUND OF THE INVENTION

A polarizing plate used in a liquid crystal display panel usually has a multi-layer film layer. Please refer to FIG. 1. FIG. 1 is a schematic structural diagram of an existing polarizing plate. The polarizing plate 10 comprises a polarizing layer 11 which plays a polarizing role, such as a polyvinyl alcohol (PVA) layer and so on, a pair of supporting layers 12 respectively adhesive to an upper surface and a lower surface of the polarizing layer 11, such as tri acetic acid cellulose (TAC) and so on, a protective layer 13 used to protect the polarizing layer 11, such as polyethylene terephthalate (PET) and so on, and a pressure-sensitive adhesive layer 14 to adhere the polarizing layer 11 to the liquid crystal display panel, such as polyisobutylene and so on. When the polarizing plate 10 is adhered to a surface of an array substrate or a color filter substrate, the protective layer 13 may be peeled and the polarizing plate 10 is disposed onto the surface of the array substrate or the color filter substrate by the pressure-sensitive adhesive layer 14.

However, when the protective layer 13 is removed from the polarizing plate 10 thereon, static electricity may be generated in the polarizing layer 11 of the polarizing plate 10 and adverse effects are produced in the display effects of the liquid crystal display panel.

In order to solve the above problem of the static electricity, an antistatic layer may be added between the pressure-sensitive adhesive layer and the supporting layer, and consists of conductive polymers, curable resins, hydroxypropionate compound, and so on. However, the antistatic layer only prevents from the effect of the static electricity to the polarizing layer, and the static electricity is still accumulated in the pressure-sensitive adhesive layer. Simultaneously, the fabricating cost of the polarizing plate is increased by the disposed antistatic layer.

As a result, it is necessary to provide a polarizing plate and a liquid crystal display panel to solve the problems existing in the conventional technologies.

### SUMMARY OF THE INVENTION

An object of the present invention is to provide a polarizing plate and a liquid crystal display panel which may effectively eliminate the static electricity and have a low fabricating cost, so as to solve technical problems that the existing polarizing plate and the liquid crystal display panel may not effectively eliminate the static electricity and have a relatively high fabricating cost.

In order to solve the above problems, the technical solution of the present invention is provided as follows:

A polarizing plate, comprising:
a polarizing layer configured to emit an incident light after performing a polarizing process;
a pair of supporting layers respectively disposed on an upper side and a lower side of the polarizing layer to protect the polarizing layer;
a surface protective layer configured to isolate an upper surface of the polarizing layer from the external environment and connected with the supporting layer located on the upper side of the polarizing layer;
a peeling protective layer configured to isolate a lower surface of the polarizing layer from the external environment and connected with the supporting layer located on the lower side of the polarizing layer by an adhesive layer; and
the adhesive layer configured to adhere the polarizing plate to an array substrate or a color filter substrate;
wherein the adhesive layer is a conductive adhesive layer with a conductive material;
wherein a material of the conductive adhesive layer includes a resin matrix, a conductive filler, a curing agent and an additive;
wherein the resin matrix includes at least one of epoxy resin, epoxy-phenolic resin, silicone resin, polyurethane, polyacrylate, acrylate copolymer, and polystyrene sulfonate-doped polyethylene dioxythiophene; and
wherein the conductive filler is graphene, carbon nanotube or silver nanowire.

An embodiment of the present invention further provides a polarizing plate, comprising:
a polarizing layer configured to emit an incident light after performing a polarizing process;
a pair of supporting layers respectively disposed on an upper side and a lower side of the polarizing layer to protect the polarizing layer;
a surface protective layer configured to isolate an upper surface of the polarizing layer from the external environment and connected with the supporting layer located on the upper side of the polarizing layer;
a peeling protective layer configured to isolate a lower surface of the polarizing layer from external environment and connected with the supporting layer located on the lower side of the polarizing layer by an adhesive layer; and
the adhesive layer configured to adhere the polarizing plate to an array substrate or a color filter substrate;
wherein the adhesive layer is a conductive adhesive layer with a conductive material.

In the polarizing plate of the present invention described, a material of the conductive adhesive layer includes a resin matrix, a conductive filler, a curing agent and an additive.

In the polarizing plate of the present invention described, the resin matrix includes at least one of epoxy resin, epoxy-phenolic resin, silicone resin, polyurethane, polyacrylate, acrylate copolymer, and polystyrene sulfonate-doped polyethylene dioxythiophene.

In the polarizing plate of the present invention described, a ratio of the resin matrix in the conductive adhesive layer is 50% to 80%.

In the polarizing plate of the present invention described, the conductive filler is graphene, carbon nanotube or silver nanowire.

In the polarizing plate of the present invention described, a ratio of the conductive filler in the conductive adhesive layer is 5% to 30%.

In the polarizing plate of the present invention described, the curing agent is trimethylamine, ethylene diamine, N,N-dimethylaniline or isocyanate compound; and the additive is silane coupling agent, levelling agent, froth preventing agent or diluent.

In the polarizing plate of the present invention described, the adhesive layer is formed by the following steps of:
mixing the resin matrix with a conductive-filler dispersion solution according to a predetermined ratio;
adding the curing agent into the mixed conductive-filler dispersion solution;
adding the additive into the conductive-filler dispersion solution after adding the curing agent, so as to obtain a coating sample with a predetermined viscosity;
coating the coating sample onto the peeling protective layer;
drying the peeling protective layer coated with the coating sample; and
adhering the peeling protective layer after the drying process to the support layer and curing to obtain the polarizing plate.

In the polarizing plate of the present invention described, the predetermined viscosity is 700 mPa·s to 900 mPa·s.

An embodiment of the present invention further provides a liquid crystal display panel, comprising: an array substrate, a color filter substrate, a liquid crystal layer and a pair of polarizing plates respectively disposed on the array substrate and the color filter substrate:
wherein each of the polarizing plates includes:
a polarizing layer configured to emit an incident light after performing a polarizing process;
a pair of supporting layers respectively disposed on an upper side and a lower side of the polarizing layer to protect the polarizing layer;
a surface protective layer configured to isolate an upper surface of the polarizing layer from the external environment and connected with the supporting layer located on the upper side of the polarizing layer;
a peeling protective layer configured to isolate a lower surface of the polarizing layer from the external environment and connected with the supporting layer located on the lower side of the polarizing layer by an adhesive layer; and
the adhesive layer configured to adhere the polarizing plate to the array substrate or the color filter substrate;
wherein the adhesive layer is a conductive adhesive layer with a conductive material.

In the liquid crystal display panel of the present invention described, a material of the conductive adhesive layer includes a resin matrix, a conductive filler, a curing agent and an additive.

In the liquid crystal display panel of the present invention described, the resin matrix includes at least one of epoxy resin, epoxy-phenolic resin, silicone resin, polyurethane, polyacrylate, acrylate copolymer, and polystyrene sulfonate-doped polyethylene dioxythiophene.

In the liquid crystal display panel of the present invention described, a ratio of the resin matrix in the conductive adhesive layer is 50% to 80%.

In the liquid crystal display panel of the present invention described, the conductive filler is graphene, carbon nanotube or silver nanowire.

In the liquid crystal display panel of the present invention described, a ratio of the conductive filler in the conductive adhesive layer is 5% to 30%.

In the liquid crystal display panel of the present invention described, the curing agent is trimethylamine, ethylene diamine, N,N-dimethylaniline or isocyanate compound; and the additive is silane coupling agent, levelling agent, froth preventing agent or diluent.

In the liquid crystal display panel of the present invention described, the adhesive layer is formed by the following steps of:
mixing the resin matrix with a conductive-filler dispersion solution according to a predetermined ratio;
adding the curing agent into the mixed conductive-filler dispersion solution;
adding the additive into the conductive-filler dispersion solution after adding the curing agent, so as to obtain a coating sample with a predetermined viscosity;
coating the coating sample onto the peeling protective layer;
drying the peeling protective layer coated with the coating sample; and
adhering the peeling protective layer after the drying process to the support layer and curing to obtain the polarizing plate.

In the liquid crystal display panel of the present invention described, the predetermined viscosity is 700 mPa·s to 900 mPa·s.

In comparison with the existing polarizing plate and the liquid crystal display panel, the polarizing plate and the liquid crystal display panel of the present invention may eliminate the static electricity better and have a lower fabricating cost. The technical problems that, the existing polarizing plate and the liquid crystal display panel may not effectively eliminate the static electricity and have a relatively high fabricating cost, are solved.

To make the above description of the present invention can be more clearly comprehensible, description below in examples of preferred embodiments with the accompanying drawings, described in detail below.

### DESCRIPTION OF THE DRAWINGS

FIG. 1 is a schematic structural diagram of an existing polarizing plate.

FIG. 2 is a schematic structural diagram of a preferred embodiment of a polarizing plate of the present invention.

FIG. 3 is a fabricating flow chat of a preferred embodiment of a polarizing plate of the present invention.

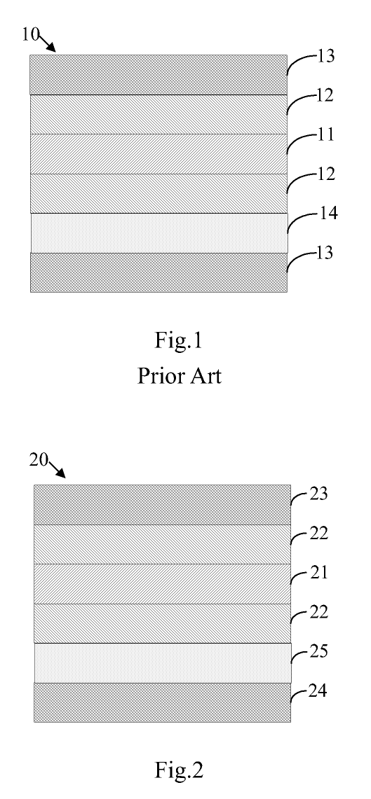

### DETAILED DESCRIPTION OF THE PREFERRED EMBODIMENTS

The following description of the embodiments with reference to the appended drawings is used for illustrating specific embodiments, which may be used for carrying out, of the present invention. The directional terms described by the present invention, such as upper, lower, front, back, left, right, inner, outer, side, and etc., are only directions by referring to the accompanying drawings. Thus, the used directional terms are used to describe and understand the present invention, but the present invention is not limited thereto.

In figures, elements with similar structures are indicated as the same numbers.

Please refer to FIG. 2. FIG. 2 is a schematic structural diagram of a preferred embodiment of a polarizing plate of the present invention. The polarizing plate 20 of the present preferred embodiment includes a polarizing layer 21, a pair of supporting layers 22, a surface protective layer 23, a peeling protective layer 24 and an adhesive layer 25. The polarizing layer 21 is configured to emit an incident light after performing a polarizing process. The supporting layers 22 are respectively disposed on an upper side and a lower side of the polarizing layer 21 to protect the polarizing layer 21. The surface protective layer 23 is configured to isolate an upper surface of the polarizing layer 21 from the external environment and connected with the supporting layer 22 located on the upper side of the polarizing layer 21. The peeling protective layer 24 is configured to isolate a lower surface of the polarizing layer 24 from the external environment and connected with the supporting layer 22 located on the lower side of the polarizing layer by an adhesive layer 25. The adhesive layer 25 is configured to adhere the polarizing plate 20 to an array substrate or a color filter substrate. In the present preferred embodiment, the adhesive layer 25 of the polarizing plate 20 is a conductive adhesive layer with a conductive material.

A material of the conductive adhesive layer includes a resin matrix, a conductive filler, a curing agent and an additive, wherein the resin matrix includes at least one of epoxy resin, epoxy-phenolic resin, silicone resin, polyurethane, polyacrylate, acrylate copolymer, and polystyrene sulfonate-doped polyethylene dioxythiophene. The conductive filler is graphene, carbon nanotube or silver nanowire and so on. The curing agent is trimethylamine, ethylene diamine, N,N-dimethylaniline or isocyanate compound and so on. The additive is silane coupling agent, levelling agent, froth preventing agent or diluent, wherein a ratio of the resin matrix in the entire conductive adhesive layer is 50% to 80%, a ratio of the conductive filler in the entire conductive adhesive layer is 5% to 30%, a ratio of the curing agent in the entire conductive adhesive layer is 1% to 5% and a ratio of the additive in the entire conductive adhesive layer is 1% to 10%. Because the nanoscale conductive filler is added into the conductive adhesive layer, the conductive adhesive layer maintains the conductive ability and keeps a respective high transmittance simultaneously.

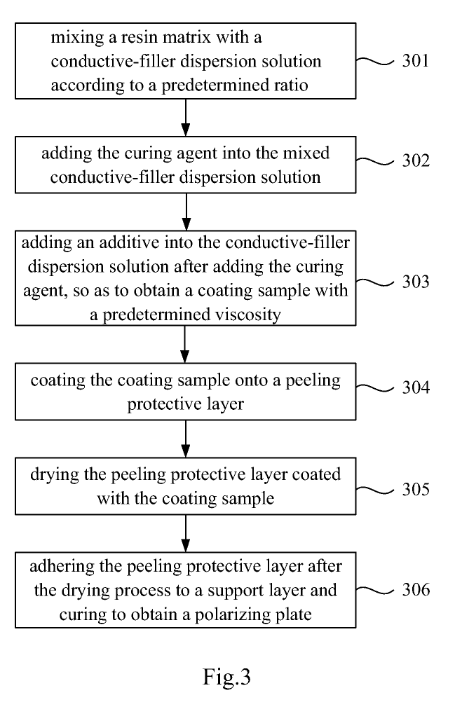

The fabricating process of the polarizing plate of the present preferred embodiment is detailed described by FIG. 3 below. FIG. 3 is a fabricating flow chat of a preferred embodiment of a polarizing plate of the present invention. The fabricating process includes:

Step S301: mixing a resin matrix with a conductive-filler dispersion solution according to a predetermined ratio;

Step S302: adding a curing agent into the mixed conductive-filler dispersion solution;

Step S303: adding the additive into the conductive-filler dispersion solution after adding the curing agent, so as to obtain a coating sample with a predetermined viscosity;

Step S304: coating the coating sample onto the peeling protective layer

Step S305: drying the peeling protective layer coated with the coating sample; and

Step S306: adhering the peeling protective layer after the drying process to the support layer and curing to obtain the polarizing plate.

The specific process of each step in a fabricating process of a polarizing plate of the present preferred embodiment is detailed described below.

In the step S301, the conductive-filler dispersion solution is produced by an oxidation-reduction method, such as the dispersion of graphene. Then, the resin matrix and the conductive-filler dispersion solution is mixed according to a predetermined ratio, such as wherein a mass ratio of the resin matrix and the conductive-filler dispersion solution is 100:20. Then, it goes to the step S302.

In the step S302, when the resin matrix in the conductive-filler dispersion solution is fully dissolved and mixed, the curing agent is added into the mixed conductive-filler dispersion solution, such as aromatic polyisocyanates with 0.5% mass fraction. Then, it goes to the step S303.

In the step S303, ethyl acetate as a dilution solvent is added into the conductive-filler dispersion solution after the curing agent is added into, so as to obtain a coating sample with a viscosity from 700 mPa·s to 900 mPa·s. Then, it goes to the step S304.

In the step S304, a coating machine is used to coat the coating sample onto the peeling protective layer, which is 25 micrometers in thickness. Then, it goes to the step S305.

In the step S305, the peeling protective layer coated the coating sampler is dried in an oven at 100 degrees Celsius. Then, it goes to the step S306.

In the step S306, after the solvent in the coating sample is fully volatilized, the peeling protective layer after the drying process is adhered to the support layer, and then the polarizing plate after being adhered is cured in a predetermined humidity environment at a setting time, so as to obtain the polarizing plate with the conductive function.

Thus, the fabricating process of the polarizing plate of the present preferred embodiment is finished.

The polarizing plate of the present preferred embodiment may be directly adhered onto the array substrate or the color filter substrate after removing the peeling protective layer, so as to export out the static electricity in the polarizing plate, the array substrate and the color filter substrate effectively and do not increase the fabricating cost of the polarizing plate simultaneously.

The present invention further provides a liquid crystal display panel, which comprises an array substrate, a color filter substrate, a liquid crystal layer disposed between the array substrate and the color filter substrate, and a pair of polarizing plates respectively disposed on an outer side of the array substrate and the color filter substrate.

The polarizing plate includes a polarizing layer, a pair of supporting layers, a surface protective layer, a peeling protective layer and an adhesive layer. The polarizing layer is configured to emit an incident light after performing a polarizing process. The supporting layers are respectively disposed on an upper side and a lower side of the polarizing layer to protect the polarizing layer. The surface protective layer is configured to isolate an upper surface of the polarizing layer from the external environment and connected with the supporting layer located on the upper side of the polarizing layer. The peeling protective layer is configured to isolate a lower surface of the polarizing layer from the external environment and connected with the supporting layer located on the lower side of the polarizing layer by an adhesive layer. The adhesive layer is configured to adhere the polarizing plate to an array substrate or a color filter substrate. The adhesive layer of the polarizing plate is a conductive adhesive layer with a conductive material.

Preferably, a material of the conductive adhesive layer includes a resin matrix, a conductive filler, a curing agent and an additive.

Preferably, the resin matrix includes at least one of epoxy resin, epoxy-phenolic resin, silicone resin, polyurethane, polyacrylate, acrylate copolymer, and polystyrene sulfonate-doped polyethylene dioxythiophene.

Preferably, a ratio of the resin matrix in the conductive adhesive layer is 50% to 80%.

Preferably, the conductive filler is graphene, carbon nanotube or silver nanowire.

Preferably, a ratio of the conductive filler in the conductive adhesive layer is 5% to 30%.

Preferably, the curing agent is trimethylamine, ethylene diamine, N,N-dimethylaniline or isocyanate compound; and the additive is silane coupling agent, levelling agent, froth preventing agent or diluent.

Preferably, the adhesive layer is formed by the following steps of:
mixing the resin matrix with a conductive-filler dispersion solution according to a predetermined ratio;
adding the curing agent into the mixed conductive-filler dispersion solution;
adding the additive into the conductive-filler dispersion solution after adding the curing agent, so as to obtain a coating sample with a predetermined viscosity;
coating the coating sample onto the peeling protective layer;
drying the peeling protective layer coated with the coating sample; and
adhering the peeling protective layer after the drying process to the support layer and curing to obtain the polarizing plate.

Preferably, the predetermined viscosity is 700 mPa·s to 900 mPa·s.

The polarizing plate and the liquid crystal display panel of the present invention may eliminate the static electricity better and have a lower fabricating cost. The technical problems that, the existing polarizing plate and the liquid crystal display panel may not effectively eliminate the static electricity and have a relatively high fabricating cost, are solved.

As described above, although the present invention has been described in a preferred embodiment described above, preferred embodiments described above are not intended to limit the invention, one of ordinary skill in the art without departing from the spirit and scope of the invention within, can make various modifications and variations, so the range of the scope of the invention defined by the claims prevail.

1. A polarizing plate, comprising:
a polarizing layer configured to emit an incident light after performing a polarizing process;
a pair of supporting layers respectively disposed on an upper side and a lower side of the polarizing layer to protect the polarizing layer;
a surface protective layer configured to isolate an upper surface of the polarizing layer from the external environment and connected with the supporting layer located on the upper side of the polarizing layer;
a peeling protective layer configured to isolate a lower surface of the polarizing layer from the external environment and connected with the supporting layer located on the lower side of the polarizing layer by an adhesive layer; and
the adhesive layer configured to adhere the polarizing plate to an array substrate or a color filter substrate;
wherein the adhesive layer is a conductive adhesive layer with a conductive material;
wherein a material of the conductive adhesive layer includes a resin matrix, a conductive filler, a curing agent and an additive;
wherein the resin matrix includes at least one of epoxy resin, epoxy-phenolic resin, silicone resin, polyurethane, polyacrylate, acrylate copolymer, and polystyrene sulfonate-doped polyethylene dioxythiophene; and
wherein the conductive filler is graphene, carbon nanotube or silver nanowire.

2. A polarizing plate, comprising:
a polarizing layer configured to emit an incident light after performing a polarizing process;
a pair of supporting layers respectively disposed on an upper side and a lower side of the polarizing layer to protect the polarizing layer;
a surface protective layer configured to isolate an upper surface of the polarizing layer from the external environment and connected with the supporting layer located on the upper side of the polarizing layer;
a peeling protective layer configured to isolate a lower surface of the polarizing layer from external environment and connected with the supporting layer located on the lower side of the polarizing layer by an adhesive layer; and
the adhesive layer configured to adhere the polarizing plate to an array substrate or a color filter substrate;
wherein the adhesive layer is a conductive adhesive layer with a conductive material.

3. The polarizing plate according to claim 2, wherein a material of the conductive adhesive layer includes a resin matrix, a conductive filler, a curing agent and an additive.

4. The polarizing plate according to claim 3, wherein the resin matrix includes at least one of epoxy resin, epoxy-phenolic resin, silicone resin, polyurethane, polyacrylate, acrylate copolymer, and polystyrene sulfonate-doped polyethylene dioxythiophene.

5. The polarizing plate according to claim 4, wherein a ratio of the resin matrix in the conductive adhesive layer is 50% to 80%.

6. The polarizing plate according to claim 3, wherein the conductive filler is graphene, carbon nanotube or silver nanowire.

7. The polarizing plate according to claim 6, wherein a ratio of the conductive filler in the conductive adhesive layer is 5% to 30%.

8. The polarizing plate according to claim 3, wherein the curing agent is trimethylamine, ethylene diamine, N,N-dimethylaniline or isocyanate compound; and the additive is silane coupling agent, levelling agent, froth preventing agent or diluent.

9. The polarizing plate according to claim 3, wherein the adhesive layer is formed by the following steps of:
mixing the resin matrix with a conductive-filler dispersion solution according to a predetermined ratio;
adding the curing agent into the mixed conductive-filler dispersion solution;
adding the additive into the conductive-filler dispersion solution after adding the curing agent, so as to obtain a coating sample with a predetermined viscosity;
coating the coating sample onto the peeling protective layer;
drying the peeling protective layer coated with the coating sample; and
adhering the peeling protective layer after the drying process to the support layer located on the lower side of the polarizing layer and curing to obtain the polarizing plate.

10. The polarizing plate according to claim 9, wherein the predetermined viscosity is 700 mPa·s to 900 mPa·s.

11. A liquid crystal display panel, comprising: an array substrate, a color filter substrate, a liquid crystal layer and a pair of polarizing plates respectively disposed on the array substrate and the color filter substrate:
wherein each of the polarizing plates includes:
a polarizing layer configured to emit an incident light after performing a polarizing process;
a pair of supporting layers respectively disposed on an upper side and a lower side of the polarizing layer to protect the polarizing layer;
a surface protective layer configured to isolate an upper surface of the polarizing layer from the external environment and connected with the supporting layer located on the upper side of the polarizing layer;
a peeling protective layer configured to isolate a lower surface of the polarizing layer from the external environment and connected with the supporting layer located on the lower side of the polarizing layer by an adhesive layer; and
the adhesive layer configured to adhere the polarizing plate to the array substrate or the color filter substrate;
wherein the adhesive layer is a conductive adhesive layer with a conductive material.

12. The liquid crystal display panel according to claim 11, wherein a material of the conductive adhesive layer includes a resin matrix, a conductive filler, a curing agent and an additive.

13. The liquid crystal display panel according to claim 12, wherein the resin matrix includes at least one of epoxy resin, epoxy-phenolic resin, silicone resin, polyurethane, polyacrylate, acrylate copolymer, and polystyrene sulfonate-doped polyethylene dioxythiophene.

14. The liquid crystal display panel according to claim 13, wherein a ratio of the resin matrix in the conductive adhesive layer is 50% to 80%.

15. The liquid crystal display panel according to claim 12, wherein the conductive filler is graphene, carbon nanotube or silver nanowire.

16. The liquid crystal display panel according to claim 15, wherein a ratio of the conductive filler in the conductive adhesive layer is 5% to 30%.

17. The liquid crystal display panel according to claim 12, wherein the curing agent is trimethylamine, ethylene diamine, N,N-dimethylaniline or isocyanate compound; and the additive is silane coupling agent, levelling agent, froth preventing agent or diluent.

18. The liquid crystal display panel according to claim 12, wherein the adhesive layer is formed by the following steps of:
mixing the resin matrix with a conductive-filler dispersion solution according to a predetermined ratio;
adding the curing agent into the mixed conductive-filler dispersion solution;
adding the additive into the conductive-filler dispersion solution after adding the curing agent, so as to obtain a coating sample with a predetermined viscosity;
coating the coating sample onto the peeling protective layer;
drying the peeling protective layer coated with the coating sample; and
adhering the peeling protective layer after the drying process to the support layer located on the lower side of the polarizing layer and curing to obtain the polarizing plate.

19. The liquid crystal display panel according to claim 18, wherein the predetermined viscosity is 700 mPa·s to 900 mPa·s.
